(19) United States
(12) Patent Application Publication
(10) Pub. No.: US 2025/0224928 A1
(43) Pub. Date: Jul. 10, 2025

(54) DRIVING ANALOG COMPUTE-IN-MEMORY CELLS USING LOW POWER SPARSITY-AWARE DIGITAL-TO-ANALOG CONVERTERS

(71) Applicant: Intel Corporation, Santa Clara, CA (US)

(72) Inventors: Hechen Wang, Portland, OR (US); Renzhi Liu, Portland, OR (US); Richard Dorrance, Beaverton, OR (US); Brent Carlton, Portland, OR (US)

(73) Assignee: Intel Corporation, Santa Clara, CA (US)

(21) Appl. No.: 19/088,078

(22) Filed: Mar. 24, 2025

(51) Int. Cl. G06F 7/523; G06F 7/50

(52) U.S. Cl. CPC G06F 7/523; G06F 7/50

(57) ABSTRACT

Some challenges to using analog compute-in-memory circuits for machine learning hardware relate to the overhead and non-idealities associated with data converters at the input and output of the analog compute-in-memory circuits. To address at least some of these challenges, a digital-to-analog converter having binary-weighted resistances can be used to drive the analog compute-in-memory circuits. The resulting digital-to-analog converter is sparsity-aware with low average power consumption. A calibration engine can perform analog tuning and/or digital post-correction to mitigate the non-idealities of the digital-to-analog converter.

### BACKGROUND

Analog compute-in-memory (CiM) performs data processing directly within memory units rather than shuttling data back and forth between separate memory and processing units. Analog CiM implementations can employ non-volatile memory technologies that can perform analog computations directly within the memory array.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates an exemplary analog CiM implementation, according to some embodiments of the disclosure.

FIG. 2 illustrates exemplary k-bit digital-to-analog converters (DACs) used in an analog CiM implementation, according to some embodiments of the disclosure.

FIG. 3 illustrates an exemplary DAC having R-weighted and 2R-weighted resistances, according to some embodiments of the disclosure.

FIG. 4 depicts a power consumption curve of the exemplary DAC of FIG. 3, according to some embodiments of the disclosure.

FIG. 5 illustrates an exemplary DAC having binary-weighted resistances, according to some embodiments of the disclosure.

FIG. 6 depicts a power consumption curve of the exemplary DAC of FIG. 5, according to some embodiments of the disclosure.

FIG. 7 illustrates an exemplary DAC having thermometer-weighted resistances, according to some embodiments of the disclosure.

FIG. 8 illustrates a segmented DAC according to some embodiments of the disclosure.

FIG. 9 illustrates a circuit implementation of a multiplication CiM unit, according to some embodiments of the disclosure.

FIG. 10 illustrates a calibration engine, according to some embodiments of the disclosure.

FIG. 11 depicts a flow chart illustrating a method for performing analog CiM processing, according to some embodiments of the disclosure.

FIG. 12 depicts a flow chart illustrating a method for performing analog CiM processing in neural networks, according to some embodiments of the disclosure.

### DETAILED DESCRIPTION

### Overview

Analog CiM computation approach offers one or more potential advantages, such as reduced power consumption by minimizing data movement, improved computational efficiency for certain workloads, potential for massively parallel processing, lower latency for specific applications, and excellent power efficiency. Because of the potential, analog CiM has garnered attention in the artificial intelligence and machine learning hardware domain. Analog CiM can be particularly promising for machine learning applications, especially neural network inference, where many matrix multiplications can be performed in parallel directly within memory arrays.

Some challenges to using analog compute-in-memory circuits for machine learning hardware relate to the overhead and non-idealities associated with data converters at the input and output of the analog CiM circuits.

At the input, a DAC is used to convert a digital signal into the analog domain and produces an analog signal as input to the analog CiM circuit. The analog CiM circuit takes the analog signal as input and performs processing in the analog domain, such as multiplication through charge sharing. At the output, an analog-to-digital converter (ADC) is used to convert an analog signal produced by the analog CiM circuit back into the digital domain.

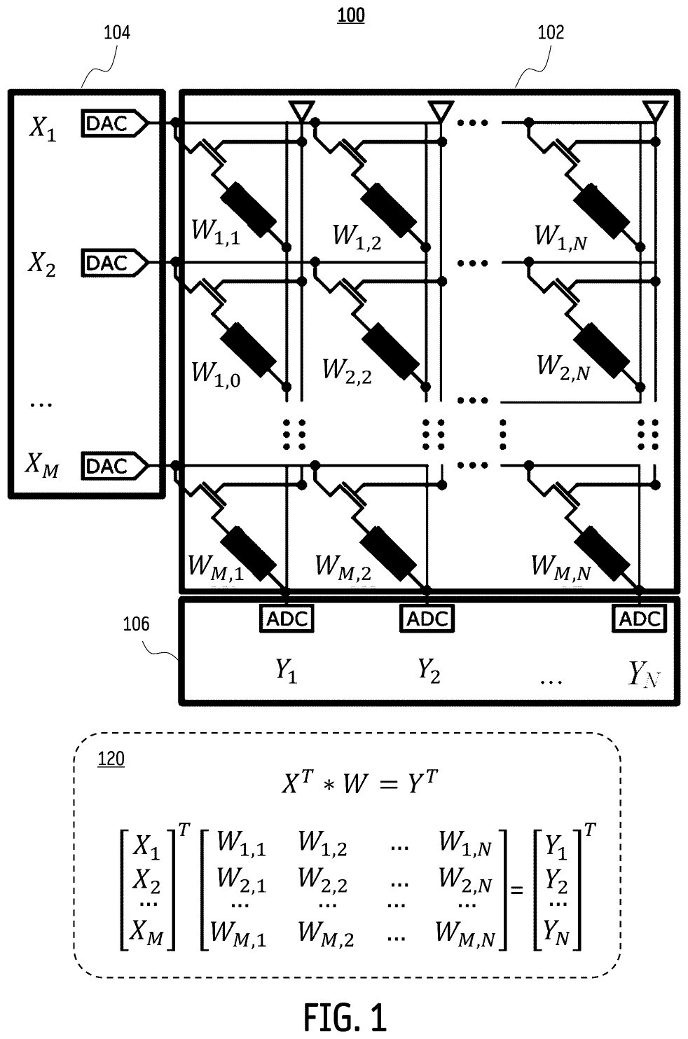

FIG. 1 illustrates an exemplary analog CiM implementation, according to some embodiments of the disclosure. Circuit 100 includes analog CiM circuit 102, one or more DACs 104, and one or more ADCs 106. Circuit 100 can form a part of a macro, or analog CiM macro (e.g., a unit that can be replicated in a chip architecture or system). Circuit 100 may be used to perform matrix multiplication 120 of X^{T}*W=Y^{T}. Matrix multiplication 120 is commonly performed in neural networks to implement fully connected layers, convolution operations, attention mechanisms in transformers, embedding conversions, etc.

One or more DACs 104 may be used to convert respective elements of input activation (IA) matrix X into analog signals. Analog CiM circuit 102 may be a multiply-accumulate circuit. Analog CiM circuit 102 can perform multiplications of the analog signals with elements of a weight matrix W. Analog CiM circuit 102 may perform accumulation (e.g., summing and/or averaging) of the products. One or more ADCs 106 may be used to convert results produced by analog CiM circuit 102 into digital signals corresponding to respective elements of output activation (OA) matrix Y. One or more DACs 104 include one or more multibit DACs to support processing multibit input activations and performing multibit multiplication with low latency and high throughput (in contrast to analog CiM circuits that implement a bit-serial operation without using a DAC).

In the context of machine learning where the analog CiM circuits (e.g., analog CiM circuit 102 of FIG. 1) are used for performing computations in each layer of a neural network, data conversions may occur one or more times for each layer of the neural network. In some implementations, the DAC may consume 25% of the overall power budget, the ADC may consume 30% of the overall power budget, and the analog CiM circuit may consume less than 50% of the overall power budget. Besides, the DACs can account for a substantial portion of the total physical area and overall latency of the macro. Designing a high-efficiency and high-performance DAC remains a non-trivial challenge.

To address at least some of these challenges, a DAC having one or more binary-weighted resistances can be used to drive the analog CiM circuits. In some embodiments, a DAC having one or more thermometer-weighted resistances can be used to drive the analog CiM circuits. In some embodiments, the DAC is a segmented DAC.

A resistor ladder-based DAC can offer adequate and flexible driving capability to fanout to multiple analog CiM units (e.g., C-2C capacitor ladder-based CiM units) without needing an additional active buffer. The DAC architecture enables a resistor ladder-based DAC to support a relatively large fanout number (e.g., by selecting suitable resistance values based on the number of analog CiM units that the DAC is driving) while conserving power and minimizing on-chip area. Rail-to-rail signal range can be easily achievable with resistor ladder-based DACs, even when operating with low headroom. Using passive components, e.g., resistor ladders without an active buffer between the DAC and the analog CiM circuit, can mean that power consumption can be reduced, and unnecessarily non-linearities associated with active components such as buffers can be avoided. Moreover, the resulting resistor ladder-based DAC can be sparsity-aware with low average power consumption when handling workloads in the machine learning context. Different examples of resistor ladder-based DACs are described herein, each with their unique improvements and advantages.

Because DACs may not always operate ideally, one or more non-idealities of the DAC (if left uncalibrated or uncorrected) can impact the overall accuracy/performance of the macro. A calibration engine can perform analog tuning and/or digital post-correction to mitigate the non-idealities of the DAC.

Different Architectures for the DAC Driving the Multiplication CiM Units and their Corresponding Improvements and Advantages

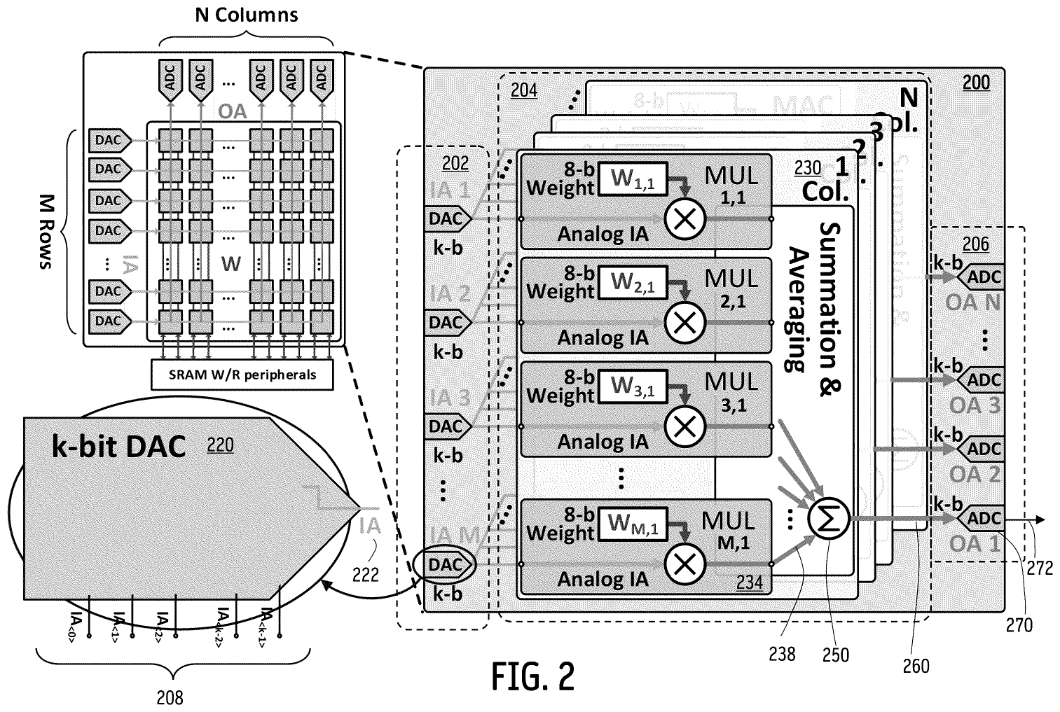

FIG. 2 illustrates exemplary k-bit DACs used in an analog CiM implementation, according to some embodiments of the disclosure. Circuit 200 may be an analog CiM macro that performs matrix multiplication, as previously illustrated in FIG. 1. In particular, circuit 200 may perform multiplication of IA matrix X having M rows or elements with a weight matrix W having M rows and N columns and generate an OA matrix Y having N columns or elements. Circuit 200 includes one or more k-bit DACs 202, or M k-bit DACs, e.g., one multibit DAC for converting each multibit input activation data word into an analog signal or an analog input activation. Circuit 200 includes one or more CiM circuits 204, or N CiM circuits for generating results corresponding to the elements of the OA matrix Y having N columns or elements. Circuit 200 includes one or more k-bit ADCs 206, or N k-bit ADCs, e.g., one multibit ADC for converting an analog result produced by a CiM circuit into a multibit output activation data word.

The one or more CiM circuits 204 includes an M-row×N-column array of analog multiplication circuitry. A row of analog multiplication circuitry takes an analog input activation generated by a k-bit DAC (e.g., one of the one or more k-bit DACs 202). An output of the k-bit DAC fanouts to N analog multiplication circuitry in N columns. The charge summation from a column of M analog multiplication circuitry can be collected and digitized by an ADC (e.g., one of one or more k-bit ADCs 206). Unlike bit-wise multiplication, circuit 200 resolves multibit multiply-accumulate operation in only one clock cycle, which leads to exceptional power and area efficiency.

A CiM circuit in the one or more CiM circuits 204 may perform multiplication of individual elements of IA matrix X with individual elements of a row of elements of the weight matrix W in the analog domain and summing the products in the analog domain to produce an element of OA matrix Y (as an analog signal). An example calculation for an element in the OA matrix Y, Y₁, is as follows:

$${Y}_{1} = {X}_{1} \cdot {W}_{1 , 1} + {X}_{2} \cdot {W}_{2 , 1} + … {X}_{M} \cdot {W}_{M , 1}$$

A further CiM circuit may perform multiplication of individual elements of IA matrix X with individual elements of a further row of elements of the weight matrix W in the analog domain and summing the products in the analog domain to produce a further element of OA matrix Y.

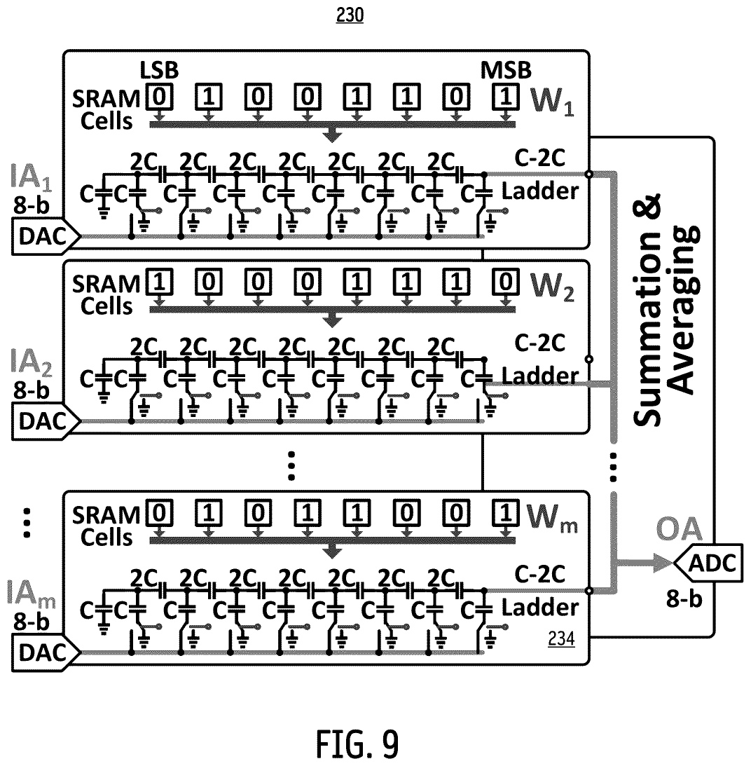

Multiplication in the analog domain may be performed using a CiM technique, where the weight (e.g., 8-bit weight) stored in memory is multiplied with the analog signal representing an input activation data word produced by a multibit DAC and products of multiplications are summed through analog circuitry. An exemplary implementation of CiM circuit 230 of one or more CiM circuits 204 is illustrated in FIG. 9.

A k-bit DAC 220 in the one or more k-bit DACs 202 may include input 208 to receive an input activation data word, e.g., a k-bit input activation data word, IA<0>, IA<1>, IA<2>, . . . IA<k−2>, and IA<k−1>. The k-bit DAC 220 may include output 222 to output an analog signal or an analog input activation. The k-bit DAC 220 may output an analog signal at output 222 based on the input activation data word received at input 208. The k-bit DAC 220 may generate an analog signal or an analog input activation at output 222 based on the input activation data word received at input 208.

A CiM circuit 230 in the one or more CiM circuits 204 may include a multiplication CiM unit 234 (labeled as MUL M,1) coupled to output 222 of k-bit DAC 220 to receive an analog signal or an analog input activation. CiM circuit 230 may perform multiplication of a weight with the analog input activation at output 222 in the analog domain. Multiplication CiM unit 234 may multiply the analog input activation at output 222 and a multiplicand (e.g., 8-bit weight W_{M,1} stored in one or more memory cells, or a p-bit weight W_{M,1} stored in one or more memory cells, etc.) to generate a product at output 238 of multiplication CiM unit 234. CiM circuit 230 may include summer 250 coupled to output 238. Summer 250 may sum output 238 of multiplication CiM unit 234 and one or more further outputs of one or more further (multiplication) compute-in-memory units (labeled as MUL 1,1, MUL, 2,1, MUL 3,1, . . . ). In some embodiments summer 250 may perform averaging. Summer 250 may sum the product at output 238 and one or more further products at the one or more further outputs of the one or more further (multiplication) compute-in-memory units to generate summed output 260. A CiM circuit, such as CiM circuit 230, may be provided for each/individual N columns of the weight matrix W.

A k-bit DAC, such as k-bit DAC 220, may be provided for each/individual element of the IA matrix X. In one example, M k-bit DACs are included in circuit 200 for M elements of the IA matrix X. A k-bit DAC may fanout to drive a corresponding multiplication CiM unit (e.g., multiplication CiM unit 234) of the one or more CiM circuits 204. In other words, a k-bit DAC may fanout to drive N multiplication CiM units.

A k-bit ADC 270 in the one or more k-bit ADCs 206 may be coupled to summed output 260 of summer 250. K-bit ADC 270 may include a digital output 272 to output an output activation data word. e.g., a k-bit output activation data word, OA<0>, OA<1>, OA<2>, . . . OA<k−2>, and OA<k−1>. k-bit ADC 270 may convert summed output 260 of summer 250 to an output activation data word. A k-bit ADC, such as k-bit ADC 270, may be provided at the output of each/individual ones of the one or more CiM circuits 204 (each one of the N CiM circuits).

While the example in FIG. 2 illustrates that the one or more k-bit DACs 202 has a resolution of k-bits, the weight has a resolution of 8-bits, and one or more k-bit ADCs 206 has a resolution of k-bits, it is envisioned that the one or more k-bit DACs 202 may have a resolution of k-bits, the weight may have a resolution of p-bits, and the one or more k-bit ADCs 206 may have a resolution of q-bits. The values, k, p, and q can be a suitable number, e.g., 1, 2, 4, 8, 16, 32, etc. A subset of the values, k, p, and q, may be the same. A subset of the values, k, p, and q may be different.

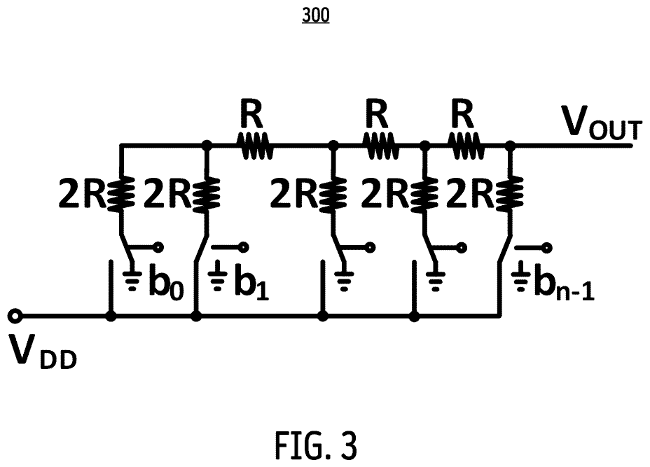

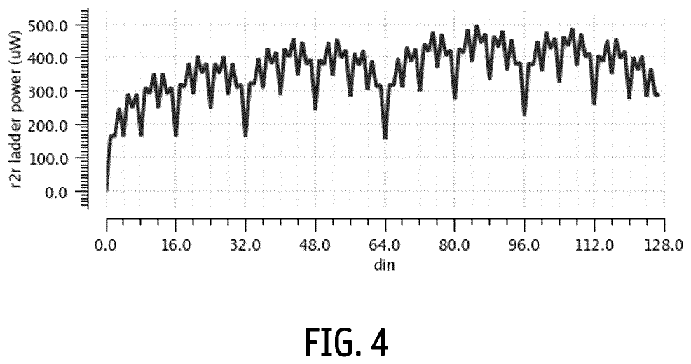

FIG. 3 illustrates exemplary DAC 300 having R-weighted and 2R-weighted resistances, according to some embodiments of the disclosure. FIG. 4 depicts a power consumption curve of exemplary DAC 300 of FIG. 3, according to some embodiments of the disclosure. DAC 300 may be included as a part of k-bit DAC 220 of FIG. 2.

DAC 300 may include R-weighted and 2R-weighted resistances forming an R-2R ladder. The R-2R ladder includes a series of cascaded resistor branches. An n-bit DAC 300 may include N cascaded resistor branches. A resistor branch may include a resistor with a two-unit resistance, 2R, and a serial resistor with a single-unit resistance, R, inserted between adjacent resistor branches. A resistor branch may receive a bit of the input activation data word. Bits of the input activation data word are depicted as b₀, b₁, . . . , or bₙ₋₁. The contribution of each resistor branch is binary-weighted by the serial resistors and cumulatively superimposed at the output node (Vₒᵤₜ) of the R-2R ladder.

The power consumption curve in FIG. 4 exhibits an input-dependent curve. Notably, the average power of DAC 300 is approximately 72% of the peak power with a uniform distribution input. DAC 300 consumes no power when the input activation data word is zero, making DAC 300 highly efficient for sparse inputs (e.g., when input activation data words are exactly zero).

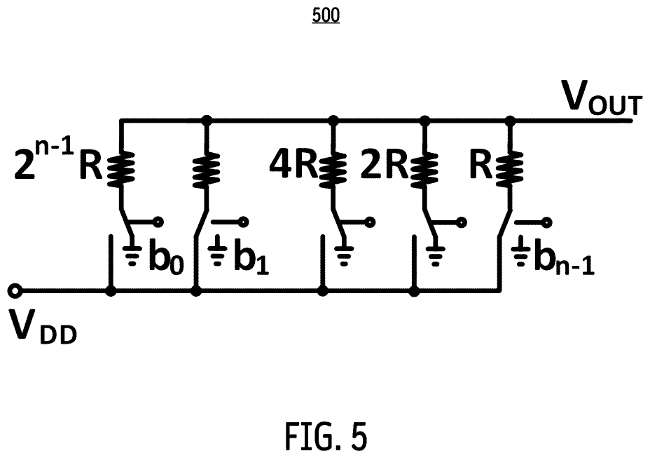

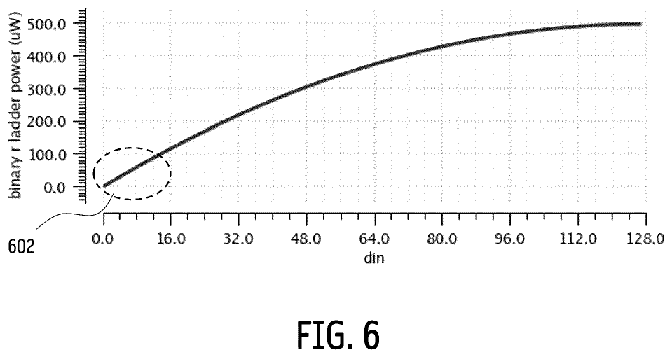

FIG. 5 illustrates exemplary DAC 500 having binary-weighted resistances, according to some embodiments of the disclosure. FIG. 6 depicts a power consumption curve of exemplary DAC 500 of FIG. 5, according to some embodiments of the disclosure.

DAC 500 may include binary-weighted resistances forming a resistor ladder. The resistor ladder for an n-bit DAC has resistors with resistances following a binary-weighted ratio of 1:2:4: . . . :2ⁿ⁻¹ along the ladder. Each part of the resistor may receive a bit of the input activation data word. Bits of the input activation data word are depicted as b₀, b₁, . . . , or bₙ₋₁. The contribution of each binary-weighted resistor is cumulatively superimposed at the output node (Vₒᵤₜ) of the resistor ladder.

While DAC 500 can use more chip area to implement binary-weighted resistors than the R-2R weighted resistors of DAC 300, DAC 500 has a distinct advantage that DAC 500 can provide even better power efficiency. The power consumption curve in FIG. 6 reveals that the average power consumption of DAC 500 is only 66% of the peak power. The actual average power consumption can depend on the data distribution of the input activations. The power consumption curve rises monotonically with the input. DAC 500 consumes no power when the input code is zero and consumes very low power when the input activation data word is close to zero. In many neural networks, sparse input activations may not always be exactly zero, but the sparse input activations are more likely to be close to zero. When the sparse input activations are more likely to be close to zero, power consumption of DAC 500 is relatively low, as seen in region 602. For such neural networks, DAC 500 can be significantly more efficient for sparse inputs (than DAC 300 of FIG. 3) when input activation data words are close to zero.

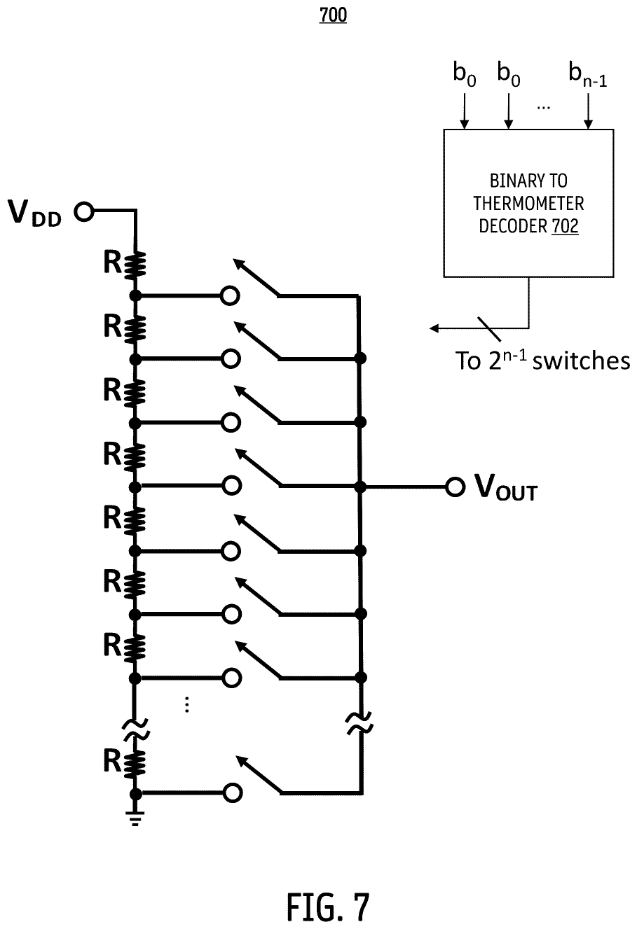

FIG. 7 illustrates exemplary DAC 700 having thermometer-weighted resistances, according to some embodiments of the disclosure. DAC 700 may include thermometer-weighted resistances forming a string of resistors. An n-bit DAC 700 may include 2ⁿ⁻¹ unit weighted resistances connected in series and 2ⁿ⁻¹ switches coupled to nodes along the string of resistances. DAC 700 may include a binary to thermometer decoder 702 to convert the input activation data word from a binary coded format to a thermometer coded format. The bits thermometer coded format is used to control a corresponding one of the 2ⁿ⁻¹ switches. The contribution of each resistor is cumulatively superimposed or summed at the output node (Vout), based on the state of the 2ⁿ⁻¹ switches. DAC 700 can generate an output which increases with the input code in uniform steps and can be highly linear.

In some implementations, k-bit DAC 220 of FIG. 2 can include a resistor-based ladder that incorporates a hybrid or blended architecture. The R-2R ladder of DAC 300 in FIG. 3 and binary-weighted ladder of DAC 500 of FIG. 5 represent two cases at the ends of spectrum. A resistor-based ladder can include a hybrid R ladder having configurations that fall between the R-2R ladder and binary-weighted ladder. For instance, half of the hybrid R ladder includes binary-weighted resistances, and the other half of the hybrid R ladder includes R-weighted and 2R-weighted resistances. A resistor-based ladder can include a hybrid R ladder having configurations that fall between the R-2R ladder and thermometer-weighted ladder. A resistor-based ladder can include a hybrid resistor ladder having configurations that fall between the binary-weighted ladder and thermometer-weighted ladder. The ladder structure can be preserved, but the resistances may have different weight ratios for different parts of the ladder.

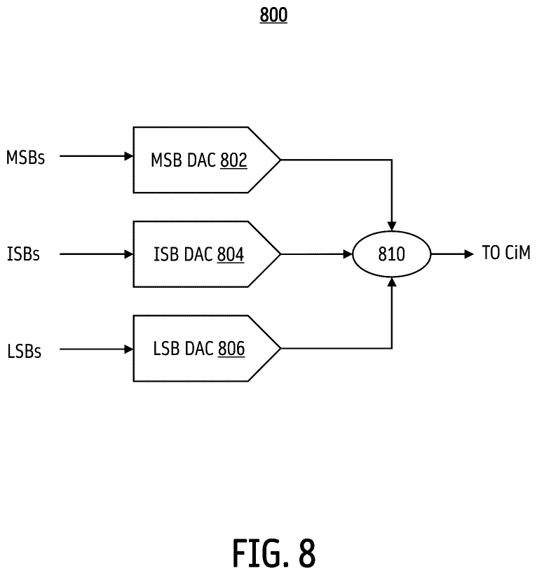

FIG. 8 illustrates segmented DAC 800 according to some embodiments of the disclosure. In some embodiments, the k-bit DAC as seen in FIG. 2 may include DAC 800. The k-bit DAC may be a segmented DAC.

Segmented DAC 800 may include two or more segments. A segment may receive a subset of bits of the input activation data word. A segment may receive the subset of bits of the input activation data word. A further segment may receive a further subset of bits of the input activation data word. A further segment may receive the further subset of bits of the input activation data word. A yet further segment may receive a yet further subset of bits of the input activation data word. A further segment may receive the yet further subset of bits of the input activation data word.

In the illustrated example, DAC 800 may include three segments, including most significant bit (MSB) DAC 802, intermediate significant bit (ISB) DAC 804, and least significant bit (LSB) DAC 806. The subset of bits received by MSB DAC 802 may include one or more MSBs. The further subset of bits received by ISB DAC 804 may include one or more ISBs. The yet further subset of bits received by LSB DAC 806 may include one or more LSBs.

It is envisioned that DAC 800 may include two segments, including MSB DAC 802, and LSB DAC 806. The subset of bits received by MSB DAC 802 may include one or more MSBs. The yet further subset of bits received by LSB DAC 806 may include one or more LSBs.

Outputs of the segments may be summed by summer 810 to produce a final analog output, which can be provided as input to a CiM circuit that is coupled to the output of DAC 800.

A segment may utilize a DAC architecture as illustrated in FIG. 3, 5, or 7. In one example, a segment may include one or more binary-weighted resistances (e.g., as illustrated in FIG. 5), and a further segment may include R-weighted and 2R-weighted resistances (e.g., as illustrated in FIG. 3). In one example, a segment may include one or more binary-weighted resistances (e.g., as illustrated in FIG. 5), and a further segment may include thermometer-weighted resistances (e.g., as illustrated in FIG. 9). In one example, a segment may include one or more R-weighted and 2R-weighted resistances (e.g., as illustrated in FIG. 3), a further segment may include thermometer-weighted resistances (e.g., as illustrated in FIG. 9).

In some embodiments, MSB DAC 802 may include thermometer-weighted resistances to ensure high linearity for the most significant bits. In some embodiments, ISB DAC 804 may include R-weighted and 2R-weighted resistances. In some embodiments, LSB DAC 806 may include binary-weighted resistances.

In some embodiments, MSB DAC 802 may include thermometer-weighted resistances to ensure high linearity for the most significant bits. In some embodiments, LSB DAC 806 may include binary-weighted resistances.

In some embodiments, MSB DAC 802 may include thermometer-weighted resistances to ensure high linearity for the most significant bits. In some embodiments, LSB DAC 806 may include R-weighted and 2R-weighted resistances.

FIG. 9 illustrates a circuit implementation of CiM circuit 230 of FIG. 2, according to some embodiments of the disclosure. CiM circuit 230 includes one or more multiplication CiM units such as multiplication CiM unit 234. Multiplication CiM unit 234 may include a capacitor ladder-based multibit multiplication circuit. For example, multiplication CiM unit 234 may include a C-2C ladder. Multiplication CiM unit 234 may include one or more static random access memory (SRAM) cells. For example, multiplication CiM unit 234 may include SRAM cells to store bits of a multiplicand.

### Exemplary Calibration Techniques for Addressing Non-Idealities of the DAC

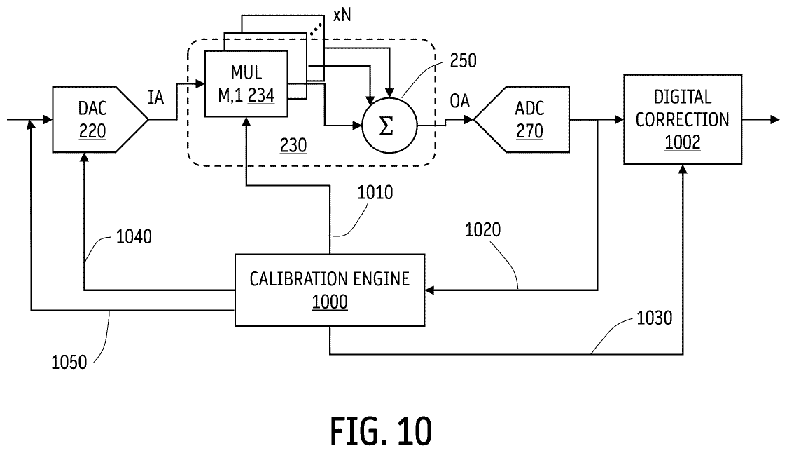

FIG. 10 illustrates calibration engine 1000, according to some embodiments of the disclosure. K-bit DAC 220 may have one or more non-idealities, which can impact the overall performance/accuracy of circuit 200 as illustrated in FIG. 2. Calibration engine 1000 can be implemented to address one or more non-idealities of k-bit DAC 220. In some implementations, calibration engine 1000 can be implemented to address one or more non-idealities of the signal chain having k-bit DAC (e.g., k-bit DAC 220), a CiM circuit (e.g., CiM circuit 230), a summer (e.g., summer 250), and a k-bit ADC (e.g., k-bit ADC 270). Examples of non-idealities of k-bit DAC 220 may include mismatches of circuit components, Integral Non-Linearity (INL), Differential Non-Linearity (DNL), offset error, gain error, noise, temperature draft, aging, etc. Other parts of the signal chain may include similar non-idealities.

Calibration engine 1000 may measure the non-idealities and implement an adjustment to circuit components and/or apply digital post-correction at the output of k-bit ADC 270 to account for the measured non-idealities. In some embodiments, calibration engine 1000 may implement a closed-loop technique to incrementally change the adjustment or the amount of digital post-correction until the measured non-ideality is minimized or reduced.

In some embodiments, calibration engine 1000 may input a predetermined input activation data word 1050 to the input of k-bit DAC 220 and to receive test data word 1020 at the output of k-bit ADC 270. Test data word 1020 may be used to measure one or more non-idealities of the signal chain. Test data word 1020 may be compared against an expected value by calibration engine 1000 to assess non-idealities of k-bit DAC 220. Calibration engine 1000 may input multiple predetermined input activation data words and receive multiple test data words generated by the signal chain.

Calibration engine 1000 may configure one or more components of the signal chain to have a predetermined state and determine an expected value at the output of k-bit ADC 270 according to the predetermined state. The actual test data word at the output of k-bit ADC 270 can be compared against the expected value to measure the non-idealities of the signal chain. In some embodiments, calibration engine 1000 may input a predetermined input activation data word 1050 to the input of the digital-to-analog converter. The signal chain may generate a test data word 1020 at the output of k-bit ADC 270 based on the predetermined input activation data word 1050. In some embodiments, calibration engine 1000 may set a predetermined multiplicand 1010 in multiplication CiM unit 234 (e.g., set predetermined multiplicand 1010 in the SRAM cells).

Calibration engine 1000 may adjust one or more of k-bit DAC 220 and the output activation data word at the output of k-bit ADC 270 based on the test data word 1020. Digital correction 1002 may be implemented to apply an adjustment or a correction at the (digital) output of k-bit ADC 270 based on correction value 1030 determined by calibration engine 1000.

In some embodiments calibration engine 1000 may determine trim setting 1040 for the one or more (binary-weighted) resistances in k-bit DAC 220 based on the test data word 1020. Trim setting 1040 can trigger one or more fuses in k-bit DAC 220 to modify the weight of a resistance in k-bit DAC 220.

In some embodiments calibration engine 1000 may determine correction value 1030 for the digital output of k-bit ADC 270 based on the test data word 1020.

### Exemplary Methods for Performing Analog CiM Processing

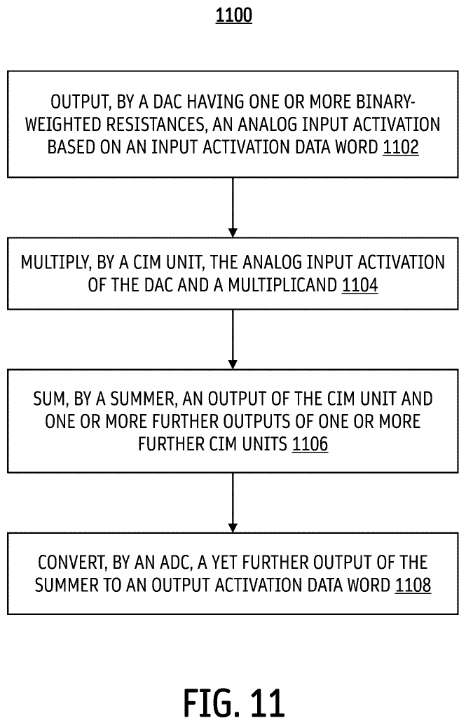

FIG. 11 depicts a flow chart illustrating method 1100 for performing analog CiM processing, according to some embodiments of the disclosure. Method 1100 may be performed by components illustrated in FIG. 2.

In 1102, a DAC comprising one or more binary-weighted resistances may output an analog signal (e.g., an analog input activation) based on an input activation data word. In some embodiments, DAC may include k-bit DAC 220 as described herein.

In 1104, a compute-in-memory unit may multiply the analog signal (e.g., an analog input activation) and a multiplicand. The compute-in-memory unit may include multiplication CiM unit 234 as described herein.

In 1106, a summer may sum an output of the compute-in-memory unit and one or more further outputs of one or more further compute-in-memory units. The summer may include summer 250 as described herein.

In 1108, an ADC may convert a yet further output of the summer to an output activation data word. The ADC may include k-bit ADC 270 as described herein.

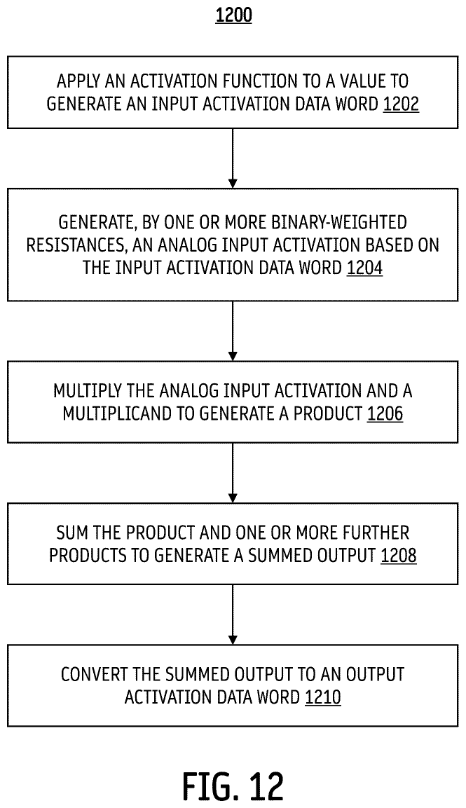

FIG. 12 depicts a flow chart illustrating method 1200 for performing analog CiM processing in neural networks, according to some embodiments of the disclosure. A DAC having the architecture as illustrated in FIG. 5 with binary-weighted resistances can achieve power savings due to sparsity-aware feature of DAC 500. In a neural network layer where all the inputs are nearly zero, DAC 500 with the binary-weighted resistances can achieve up to a 95% reduction in power usage. In one experiment where a neural network is applied to process images, in a majority of the layers of the neural network, more than 50% of the activation outputs are zero, with many of the deeper layers having up to 90% of the activation outputs being zero. The result of the experiment means that a large portion of DAC conversion power can be saved by using the architecture as illustrated in FIG. 5.

In 1202, an activation function is applied to a value to generate an input activation data word. The value may be a value generated by a previous layer in a neural network. The input activation data word is part of an input to a next layer in a neural network.

In 1204, one or more binary-weighted resistances of a DAC can generate an analog signal (e.g., an analog input activation) based on the input activation data word. In some embodiments, DAC may include k-bit DAC 220 as described herein.

In 1206, the analog signal and a multiplicand are multiplied together to generate a product. The multiplication can be performed by multiplication CiM unit 234 as described herein.

In 1208, the product and one or more further products are summed to generate a summed output. The summing may be performed by summer 250 as described herein.

In 1210, the summed output may be converted to an output activation data word. The conversion may be performed by k-bit ADC 270 as described herein.

A variety of activation functions may produce sparse values, where outputs of the activation function are zero-valued or have values close to zero. Activation functions are not limited to the ones explicitly mentioned herein.

In some embodiments, the activation function is a Rectified Linear Unit (ReLU) function that outputs a zero value for the input activation data word in response to the value being negative. The ReLU function may output the value in response to the value being positive. The ReLU funcation can be defined as: f(x)=max(0, x).

In some embodiments, the activation function is a Leaky ReLU function. The Leaky ReLU function can be defined as: f(x)=max(αx, x), where α is a small constant (typically 0.01). Unlike ReLU, it allows a small gradient when the unit is not active.

In some embodiments, the activation function is a parametric ReLU function. The parametric ReLU function can be defined as: f(x)=max(αx, x), where α is a small constant and is a learnable parameter.

In some embodiments, the activation function is a ReLU6 function. The ReLU6 function can be defined as: f(x)=min (max(0, x), 6). ReLU6 is similar to ReLU but with an upper bound of 6.

In some embodiments, the activation function is a hard shrink function. The hard shrink function can be defined as: f(x)=x if x>λ or x<−λ, else 0. λ is a positive threshold parameter, and the hard shrink function returns zero for inputs in the range [−λ, λ].

In some embodiments, the activation function is a threshold function. The threshold function can be defined as: f(x)=1 if x>threshold, else 0. The threshold function is a binary step function that outputs either 0 or 1 based on the threshold.

In some embodiments, the activation function is a Softplus function. The Softplus function can be defined as: f(x)=log(1+e\hat{ }x). The Softplus function is a smooth approximation to ReLU function that approaches zero for large negative values.

In some embodiments, the activation function is an Exponential Linear Unit (ELU) function. The ELU function can be defined as: f(x)=x if x>0, else α(e\hat{ }x−1). α is a tunable parameter. For negative values, the ELU function approaches −α asymptotically.

In some embodiments, the activation function is a Scaled Exponential Linear Unit (SELU) function. The SELU function can be defined as: f(x)=λ*x if x>0, else λ*α*(e\hat{ }x−1). λ and α are predefined constants (λ≈1.0507, α≈1.6733) chosen to ensure self-normalization.

In some embodiments, the activation function is a Gaussian Error Linear Unit (GELU) function. The GELU function can be defined as x*ϕ(x) where ϕ is the cumulative distribution function of the standard normal distribution.

### SELECT EXAMPLES

Example 1 provides an apparatus, including a digital-to-analog converter including one or more binary-weighted resistances, an input to receive an input activation data word, and an output to output an analog input activation; a multiplication compute-in-memory unit coupled to the output of the digital-to-analog converter; a summer coupled to an output of the multiplication compute-in-memory unit; and an analog-to-digital converter coupled to a further output of the summer, the analog-to-digital converter including a digital output to output an output activation data word.

Example 2 provides the apparatus of example 1, where: the digital-to-analog converter includes a segment to receive a subset of bits of the input activation data word and a further segment to receive a further subset of bits of the input activation data word; the segment includes the one or more binary-weighted resistances; and the further segment includes R-weighted and 2R-weighted resistances.

Example 3 provides the apparatus of example 1 or 2, where: the digital-to-analog converter includes a segment to receive a subset of bits of the input activation data word and a further segment to receive a further subset of bits of the input activation data word; the segment includes the one or more binary-weighted resistances; and the further segment includes one or more thermometer-weighted resistances.

Example 4 provides the apparatus of any one of examples 1-3, further including a calibration engine to input a predetermined input activation data word to the input of the digital-to-analog converter and to receive a test data word.

Example 5 provides the apparatus of example 4, where the calibration engine is further to set a predetermined multiplicand in the multiplication compute-in-memory unit.

Example 6 provides the apparatus of example 4 or 5, where the calibration engine is to determine a trim setting for the one or more binary-weighted resistances based on the test data word.

Example 7 provides the apparatus of any one of examples 4-6, where the calibration engine is to determine a correction value for the digital output of the analog-to-digital converter based on the test data word.

Example 8 provides the apparatus of any one of examples 1-7, where the multiplication compute-in-memory unit includes capacitor ladder-based multibit multiplication circuit.

Example 9 provides the apparatus of any one of examples 1-8, where the multiplication compute-in-memory unit includes one or more static random access memory cells.

Example 10 provides a method, including outputting, by a digital-to-analog converter including one or more binary-weighted resistances, an analog input activation based on an input activation data word; multiplying, by a compute-in-memory unit, the analog input activation and a multiplicand; summing, by a summer, an output of the compute-in-memory unit and one or more further outputs of one or more further compute-in-memory units; and converting, by an analog-to-digital converter, a yet further output of the summer to an output activation data word.

Example 11 provides the method of example 10, further including receiving, by a segment of the digital-to-analog converter having the one or more binary-weighted resistances, a subset of bits of the input activation data word; and receiving, by a further segment of the digital-to-analog converter having R-weighted and 2R-weighted resistances, a further subset of bits of the input activation data word.

Example 12 provides the method of example 10 or 11, further including receiving, by a segment of the digital-to-analog converter having the one or more binary-weighted resistances, a subset of bits of the input activation data word; and receiving, by a further segment of the digital-to-analog converter having one or more thermometer-weighted resistances, a further subset of bits of the input activation data word.

Example 13 provides the method of any one of examples 10-12, further including inputting a predetermined input activation data word to an input of the digital-to-analog converter; generating a test data word based on the predetermined input activation data word; and adjusting one or more of the digital-to-analog converter and the output activation data word based on the test data word.

Example 14 provides the method of example 13, further including setting a predetermined value for the multiplicand in the compute-in-memory unit.

Example 15 provides the method of example 13 or 14, further including determining a trim setting for the one or more binary-weighted resistances based on the test data word.

Example 16 provides the method of any one of examples 13-15, further including determining a digital correction value for a digital output of the analog-to-digital converter based on the test data word.

Example 17 provides a method, including applying an activation function to a value to generate an input activation data word; generating, by one or more binary-weighted resistances, an analog input activation based on the input activation data word; multiplying the analog input activation and a multiplicand to generate a product; summing the product and one or more further products to generate a summed output; and converting the summed output to an output activation data word.

Example 18 provides the method of example 17, where the activation function is a rectified linear unit function that outputs a zero value for the input activation data word in response to the value being negative.

Example 19 provides the method of example 17 or 18, further including applying a predetermined input activation data word as the input activation data word; generating a test data word based on the predetermined input activation data word; and adjusting one or more of the one or more binary-weighted resistances and the output activation data word based on the test data word.

Example 20 provides the method of example 19, further including setting a predetermined value for the multiplicand.

Example A provides an apparatus comprising means for implementing a method according to any one of examples 10-20.

Example B provides a circuit comprising one or more DACs and one or more CiM circuits as described herein.

Example C provides an analog CiM macro as described herein.

### VARIATIONS AND OTHER NOTES

As used herein, the term “coupled to” or “coupled with” refers to a relationship between electronic components or circuit elements wherein the components are in electronic communication with one another and capable of transmitting and/or receiving electrical signals between them. The term “coupled to” does not require a direct physical or electrical connection between the coupled components. Rather, “coupled to” can encompass arrangements where the components are connected through one or more intervening elements, components, circuits, or transmission paths. For example, a first component may be “coupled to” a second component through intermediate components such as resistors, capacitors, inductors, transistors, logic gates, buses, transformers, or other electronic components, or through intermediate transmission paths, while still maintaining the capability for electronic communication between the first and second components.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

For purposes of explanation, specific numbers, materials and configurations are set forth in order to provide a thorough understanding of the illustrative implementations. However, it will be apparent to one skilled in the art that the present disclosure may be practiced without the specific details and/or that the present disclosure may be practiced with only some of the described aspects. In other instances, well known features are omitted or simplified in order not to obscure the illustrative implementations.

Further, references are made to the accompanying drawings that form a part hereof, and in which are shown, by way of illustration, embodiments that may be practiced. It is to be understood that other embodiments may be utilized, and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the disclosed subject matter. However, the order of description should not be construed as to imply that these operations are necessarily order dependent. In particular, these operations may not be performed in the order of presentation. Operations described may be performed in a different order from the described embodiment. Various additional operations may be performed or described operations may be omitted in additional embodiments.

For the purposes of the present disclosure, the phrase “A or B” or the phrase “A and/or B” means (A), (B), or (A and B). For the purposes of the present disclosure, the phrase “A, B, or C” or the phrase “A, B, and/or C” means (A), (B), (C), (A and B), (A and C), (B and C), or (A, B, and C). The term “between,” when used with reference to measurement ranges, is inclusive of the ends of the measurement ranges.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking or in any other manner.

In the following detailed description, various aspects of the illustrative implementations will be described using terms commonly employed by those skilled in the art to convey the substance of their work to others skilled in the art.

The terms “substantially,” “close,” “approximately,” “near,” and “about,” generally refer to being within +/−20% of a target value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value as described herein or as known in the art.

In addition, the terms “comprise,” “comprising,” “include,” “including,” “have,” “having” or any other variation thereof, are intended to cover a non-exclusive inclusion. For example, a method, process, or device, that comprises a list of elements is not necessarily limited to only those elements but may include other elements not expressly listed or inherent to such method, process, or device. Also, the term “or” refers to an inclusive “or” and not to an exclusive “or.”

The systems, methods and devices of this disclosure each have several innovative aspects, no single one of which is solely responsible for all desirable attributes disclosed herein. Details of one or more implementations of the subject matter described in this specification are set forth in the description and the accompanying drawings.

1. An apparatus, comprising:
a digital-to-analog converter comprising one or more binary-weighted resistances, an input to receive an input activation data word, and an output to output an analog input activation;
a multiplication compute-in-memory unit coupled to the output of the digital-to-analog converter;
a summer coupled to an output of the multiplication compute-in-memory unit; and
an analog-to-digital converter coupled to a further output of the summer, the analog-to-digital converter comprising a digital output to output an output activation data word.

2. The apparatus of claim 1, wherein:
the digital-to-analog converter comprises a segment to receive a subset of bits of the input activation data word and a further segment to receive a further subset of bits of the input activation data word;
the segment comprises the one or more binary-weighted resistances; and
the further segment comprises R-weighted and 2R-weighted resistances.

3. The apparatus of claim 1, wherein:
the digital-to-analog converter comprises a segment to receive a subset of bits of the input activation data word and a further segment to receive a further subset of bits of the input activation data word;
the segment comprises the one or more binary-weighted resistances; and
the further segment comprises one or more thermometer-weighted resistances.

4. The apparatus of claim 1, further comprising:
a calibration engine to input a predetermined input activation data word to the input of the digital-to-analog converter and to receive a test data word.

5. The apparatus of claim 4, wherein the calibration engine is further to set a predetermined multiplicand in the multiplication compute-in-memory unit.

6. The apparatus of claim 4, wherein the calibration engine is to determine a trim setting for the one or more binary-weighted resistances based on the test data word.

7. The apparatus of claim 4, wherein the calibration engine is to determine a correction value for the digital output of the analog-to-digital converter based on the test data word.

8. The apparatus of claim 1, wherein the multiplication compute-in-memory unit comprises capacitor ladder-based multibit multiplication circuit.

9. The apparatus of claim 1, wherein the multiplication compute-in-memory unit comprises one or more static random access memory cells.

10. A method, comprising:
outputting, by a digital-to-analog converter comprising one or more binary-weighted resistances, an analog input activation based on an input activation data word;
multiplying, by a compute-in-memory unit, the analog input activation and a multiplicand;
summing, by a summer, an output of the compute-in-memory unit and one or more further outputs of one or more further compute-in-memory units; and
converting, by an analog-to-digital converter, a yet further output of the summer to an output activation data word.

11. The method of claim 10, further comprising:
receiving, by a segment of the digital-to-analog converter having the one or more binary-weighted resistances, a subset of bits of the input activation data word; and
receiving, by a further segment of the digital-to-analog converter having R-weighted and 2R-weighted resistances, a further subset of bits of the input activation data word.

12. The method of claim 10, further comprising:
receiving, by a segment of the digital-to-analog converter having the one or more binary-weighted resistances, a subset of bits of the input activation data word; and
receiving, by a further segment of the digital-to-analog converter having one or more thermometer-weighted resistances, a further subset of bits of the input activation data word.

13. The method of claim 10, further comprising:
inputting a predetermined input activation data word to an input of the digital-to-analog converter;
generating a test data word based on the predetermined input activation data word; and
adjusting one or more of the digital-to-analog converter and the output activation data word based on the test data word.

14. The method of claim 13, further comprising:
setting a predetermined value for the multiplicand in the compute-in-memory unit.

15. The method of claim 13, further comprising:
determining a trim setting for the one or more binary-weighted resistances based on the test data word.

16. The method of claim 13, further comprising:
determining a digital correction value for a digital output of the analog-to-digital converter based on the test data word.

17. A method, comprising:
applying an activation function to a value to generate an input activation data word;
generating, by one or more binary-weighted resistances, an analog input activation based on the input activation data word;
multiplying the analog input activation and a multiplicand to generate a product;
summing the product and one or more further products to generate a summed output; and
converting the summed output to an output activation data word.

18. The method of claim 17, wherein the activation function is a rectified linear unit function that outputs a zero value for the input activation data word in response to the value being negative.

19. The method of claim 17, further comprising:
applying a predetermined input activation data word as the input activation data word;
generating a test data word based on the predetermined input activation data word; and
adjusting one or more of the one or more binary-weighted resistances and the output activation data word based on the test data word.

20. The method of claim 19, further comprising:
setting a predetermined value for the multiplicand.
